(19) United States
(12) Patent Application Publication
(10) Pub. No.: US 2010/0024425 A1
(43) Pub. Date: Feb. 4, 2010

(54) TURBINE ENGINE FUEL NOZZLE

(75) Inventors: David W. Cihlar, Greenville, SC (US); William L. Byrne, Simpsonville, SC (US); Marcus B. Huffman, Simpsonville, SC (US); Matthew B. Wilson, Greer, SC (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: General Electric Company

(21) Appl. No.: 12/183,098

(22) Filed: Jul. 31, 2008

(51) Int. Cl. F02C 7/22; B05B 1/00; F23R 3/28

(52) U.S. Cl. 60/734; 239/589

(57) ABSTRACT

A fuel nozzle for a gas turbine combustor that includes an extended flange. At a first end, the extended flange may be configured to engage an end cover, thereby securing the position of the fuel nozzle within the combustor. At a second end, the extended flange may be configured to engage a swozzle, within which a supply of fuel and compressed air is mixed during the operation of the combustor. The extended flange may be formed as a single piece.

### BACKGROUND OF THE INVENTION

This present application relates generally to fuel nozzle assemblies that are used in combustors of gas turbines engines. More specifically, but not by way of limitation, the present application relates to a combined flange/outer tube assembly that may be used in gas turbine fuel nozzles.

Generally, a fuel nozzle assembly is utilized to deliver a mixture of fuel and air to the combustion chamber. One component of the fuel nozzle assembly is a flange, which connects the fuel nozzle assembly to an end cover. The flange secures the fuel nozzle directly to the end cover. The flange also connects to an outer tube that attaches to a fuel/air swirler or swozzle at its other end. As one of ordinary skill in the art will appreciate, the fuel nozzle generally behaves as a cantilevered beam, with the flange and the outer tube supporting the entire fuel nozzle structure that extends away from the end cover into the combustor. In use, the flange and outer tube generally provide structural support for the fuel nozzle and fuel passages through a concentric tube arrangement.

However, in conventional fuel nozzles, flange and outer tube design fails to provide durable support for the fuel nozzle. Further, among other shortcomings, conventional design fails to provide surface profiles that minimize aerodynamic interference and stress concentrations. Thus, there is a need for enhanced fuel nozzle design, particularly the design of the flange and outer tube, that addresses the issues of conventional apparatus.

### BRIEF DESCRIPTION OF THE INVENTION

The present application thus describes a fuel nozzle for a gas turbine combustor that includes an extended flange. At a first end, the extended flange may be configured to engage an end cover, thereby securing the position of the fuel nozzle within the combustor. At a second end, the extended flange may be configured to engage a swozzle, within which a supply of fuel and compressed air is mixed during the operation of the combustor. The extended flange may be formed as a single piece.

The present application also describes a fuel nozzle for a gas turbine combustor that includes an extended flange. At a first end, the extended flange may be configured to engage an end cover, thereby securing the position of the fuel nozzle within the combustor. At a second end, the extended flange may be configured to engage a swozzle, within which a supply of fuel and compressed air is mixed during the operation of the combustor. The extended flange may be formed as a single piece. The extended flange also may include a flange section, a middle section, and a tube section. The flange section may have a cylindrical shape. The middle section may include a curved surface that transitions from a surface of the flange section to a surface of the tube section. The tube section comprises a cylindrical shape that extends away from the middle section. Finally, the curved surface that transitions from the surface of the flange section to the surface of the tube section may have an approximate smooth elliptical surface.

These and other features of the present application will become apparent upon review of the following detailed description of the preferred embodiments when taken in conjunction with the drawings and the appended claims.

### BRIEF DESCRIPTION OF THE DRAWINGS

These and other objects and advantages of this invention will be more completely understood and appreciated by careful study of the following more detailed description of exemplary embodiments of the invention taken in conjunction with the accompanying drawings, in which:

FIG. 1 is a section view of an exemplary combustor of a gas turbine engine in which certain embodiment of the present invention may be used;

FIG. 2 is a section view of a conventional combustor fuel nozzle that is used in gas turbine engines;

FIG. 3 is a perspective view of a fuel nozzle flange according to an exemplary embodiment of the present invention;

FIG. 4 is a section view of the fuel nozzle flange of FIG. 3; and

FIG. 5 is a section view of a combustor fuel nozzle in which the nozzle flange of FIG. 3 is used.

### DETAILED DESCRIPTION OF THE INVENTION

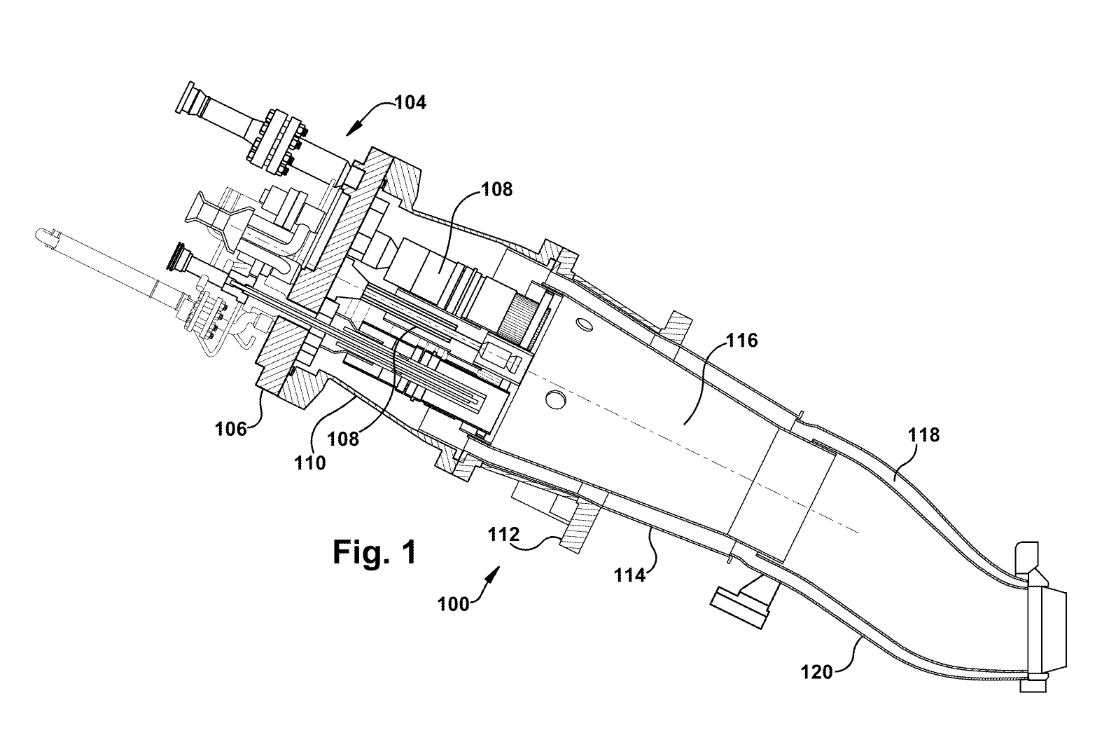

Referring now to the figures, where the various numbers represent like parts throughout the several views, FIG. 1 illustrates a combustion system 100, which includes an exemplary combustor that may be used in a gas turbine engine. Embodiments of the present invention may be used in the combustion system 100, as described in more detail later. As one of ordinary skill in the art will appreciate, combustion system 100 may include a headend 104, which generally includes the various manifolds that supply the necessary air and fuel to the combustion system 100, and an end cover 106. A plurality of fuel nozzles 108 may be fixed to the end cover 106. As one of ordinary skill where will appreciate, in gas turbine engines, fuel nozzles 108 deliver a mixture of fuel and air to the combustion system 100 for combustion. The fuel, for example, may be natural gas and the air may be compressed air supplied from an axial compressor (not shown) that is part of the gas turbine engine. The fuel nozzles 108 may be located inside of a forward case 110 that attaches to the end cover 106 and encloses the fuel nozzles 108. As one of ordinary skill in the art will appreciate, downstream of the fuel nozzles 108, generally, an aft case 112 may enclose a flow sleeve 114. The flow sleeve 114, in turn, may enclose a liner 116. A transition piece assembly 118 may direct the flow downstream to the turbine section (not shown) of the gas turbine engine. A transition piece impingement sleeve 120 may enclose the transition piece assembly 118, creating a channel between the transition piece impingement sleeve 120 and the transition piece assembly 118.

In use, a supply of compressed air from the axial compressor may enter the combustion system 100 through small perforations or holes in the transition piece impingement sleeve 120. The compressed air may them move between the channel formed between the transition piece impingement sleeve 120 and the transition piece assembly 118, in the direction of the headend 104. The supply of compressed air may continue in that direction through the channel formed between the liner 116 and the flow sleeve 114. From there, the compressed air may flow into the volume bound by the forward case 110 and enter the fuel nozzles 108 through the inlet flow conditioner 142. At the fuel nozzles 108, generally, the supply of compressed air may be mixed with a supply of fuel, which is provided by a fuel manifold that connects to the fuel nozzles 108 through the end cover 106. The supply of compressed air and fuel is combusted as it exits the fuel nozzles 108, which creates a flow of rapidly moving hot gases that is directed downstream through the cavities within the liner 116 and the transition piece assembly 108 toward the turbine section, where the energy of the flow may be converted into the mechanical energy of rotating turbine blade airfoils.

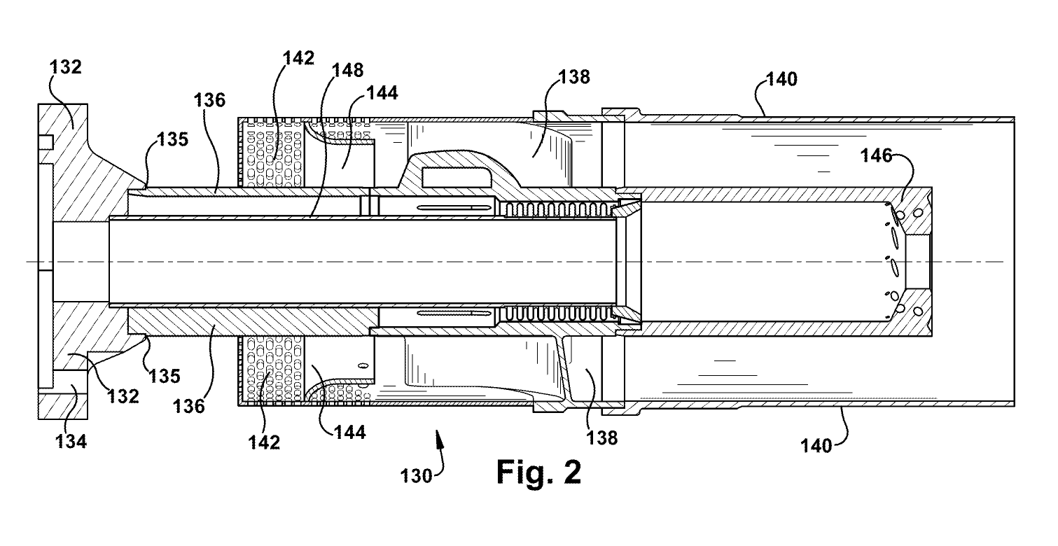

FIG. 2 illustrates a section view of a conventional fuel nozzle 130. In general, the fuel nozzle 130 includes a flange 132, which may include several bolt holes 134 that are used to secure the fuel nozzle 132 in place to the end cover 106. In general, the axial thickness of the flange 132 is between approximately 0.5 and 1.0 inches. Attached to the flange 132 at points 135, is an outer tube 136. The outer tube 136 typically is welded or brazed to the flange 132. The outer tube 136 extends away from the flange 132 and connects to a swozzle 138. Though the length of the outer tube 136 made vary depending on the application, in general, the length of the outer tube 136, i.e., the axial distance it extends from the flange 132 it is between approximately 3.0 and 9.0 inches. Thus, the combined length of a conventional flange 132/outer tube 136 assembly is generally between approximately 3.5 to 10.0 inches. The outer tube 136 typically is welded or brazed to the swozzle 138. As one of ordinary skill in the art will appreciate, the swozzle 130 is the part in the fuel nozzle 108 in which a supply of fuel and compressed air is mixed. The swozzle 130 does this by being configured with individual vanes that contain a cored center in which fuel enters from the annular cavity created between the outer tube 136 and an inner tube 148. Circumferential holes in the vane provide a passage in which the fuel travels into the compressed air flow path.

An exterior tube may enclose approximately 75% of the fuel nozzle 130. At the section of the exterior tube that overlaps the outer tube 136, small holes or perforations may form an inlet flow conditioner 142. Inside the inlet flow conditioner 142, is an inlet flow conditioner baffle 144. Extending away from the swozzle 138 is a diffuser tip 146. The section of the exterior tube that covers the diffusion tip 146 may form a burner tube 140. The inner tube 148 may be formed inside the outer tube 136, creating a concentric circle channel between the inner tube 148 and the outer tube 136 and another channel inside the hollow inner tube 148. These channels may be used to supply fuels to the fuel nozzle 108.

The conventional fuel nozzle 130 may operate as follows. Compressed air, which may be supplied an axial compressor, may flow into the forward case 110 of the combustion system 100 and may enter the fuel nozzle 130 through the perforations of the inlet flow conditioner 142. It will be appreciated that the flow of compressed air in the forward case 10 generally must change direction to enter the inlet flow conditioner 142, that some of the compressed air will be deflected off of the flange 132 toward the inlet flow conditioner 142, and that flow in this area generally will be turbulent. A fuel, such as natural gas, may enter the nozzle 130 through a channel through the flange 132. The fuel may flow toward the swozzle 138 in the channel formed between the outer tube 136 and the inner tube 148. Note that liquid fuels and purge air may be supplied through the channel formed inside the inner tube 148. The fuel and the compressed air may mix in the swozzle 138 and exit through the far end of the burner tube 140 where it is combusted.

Those of ordinary skill in the art will appreciate that fuel nozzles generally are highly stressed parts. The operational stresses include vibratory loads, thermal loads, aerodynamic loads, and others. As one of ordinary skill in the art will appreciate, fuel nozzles 108 are cantilevered parts, i.e., fuel nozzles 108 are structurally supported by the connection they make to the end cover 106 through the outer tube 136/flange 132 assembly. As a result, high stress concentrations occur through the outer tube 136 and flange 132 parts.

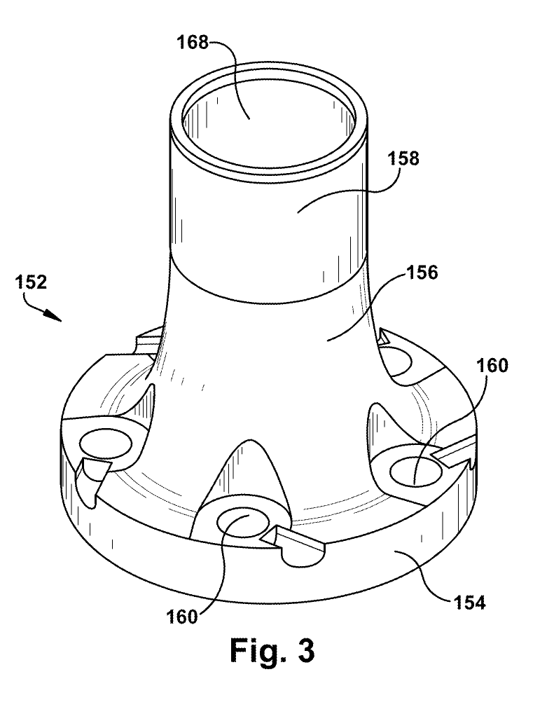

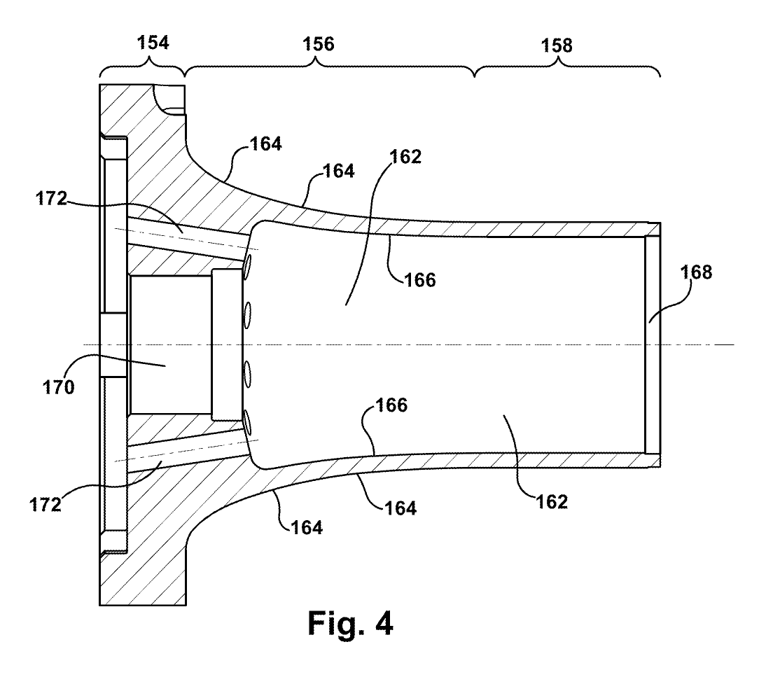

FIGS. 3 and 4 illustrate two views of an integrated fuel nozzle flange/outer tube 152 according to an exemplary embodiment of the present application (hereinafter, though the name is not intended to be limiting in any way, the “integrated fuel nozzle flange/outer tube 152” will be referred to as “extended flange 152”). FIG. 3 illustrates a perspective view, and FIG. 4 illustrates a section view. As shown, the extended flange 152 may include a flange section 154, a middle section 156, and a tube section 158. The flange section 154 generally may be a flange that is cylindrical in shape, though other shapes are possible. Through the flange section 154, there may be a plurality of apertures 160 through which bolts (not shown) may secure the extended flange 152 to the end cover 106. In some embodiments, the cylindrical flange of the flange section 154 is generally between 1.0 and 3.5 inches in diameter. The axial thickness of the flange section 154 is generally between 0.25 and 0.75 inches.

The middle section 156 generally is the section that makes the transition from the flange section 154 to the tube section 158. As illustrated, the middle section 156 is an approximate flared cylinder. The flared cylinder of the middle section 156 generally has a larger diameter where the middle section 156 connects to the flange section 154 and a smaller diameter where the middle section 156 connects to the tube section 158. It will be appreciated that the flange section 154 is generally a piece that extends in the radial direction (or, as illustrated, the vertical direction), while the tube section 158 is a section that generally extends in the axial direction (or, as illustrated, the horizontal direction), away from the flange section 154. That is, the middle section 156 transitions from a radially oriented surface (or, as illustrated, a vertical surface) of the flange section 154 to an axially oriented surface (or, as illustrated, a horizontal surface) of the tube section 158 with an approximate smooth elliptical surface. In some embodiments, the middle section 156 transitions from the radially oriented surface of the flange section 154 to the axially oriented surface of the tube section 158 with an approximate smooth multi-radial curve. The axial thickness of the middle section 156 is generally between 0.5 and 1.0 inches.

Finally, the tube section 158 is a section of tube that extends in the axial direction (or, as illustrated, the horizontal direction) away from the middle section 156. In some embodiments, the tube section 150 is an approximate cylinder shape, though other shapes are possible. The axial thickness of the tube section 158 is generally between 3.0 and 9.0 inches. Note that, though the extended flange 152 has been described in terms of three sections, the extended flange 152 may be constructed as an integral part. The axial thickness of the extended flange 152 is generally between 3.75 and 10.75 inches. In some environments, the axial thickness of the extended flange 152 is the distance required such that, when one end of the extended flange 152 is connected to the end cover 106 and the other end is connected to the swozzle 138, the fuel nozzle is appropriately positioned in the combustor.

As illustrated in FIG. 4, internal passages may extend through the extended flange 152. A central chamber 162 may be formed in the middle section 156 and may extend through the tube section 158, as illustrated. Where the central chamber 162 is formed within the extended flange 152, the extended flange 152 may have a form that is similar to a cylindrical pipe or tube that is substantially hollow (note that where the central chamber 162 is formed within the middle section 156, the cylindrical pipe or tube shape may be flared somewhat). That is, where the central chamber 162 is formed within the extended flange 152, a relatively thin wall thickness may separate an outer surface 164 from an inner surface 166, with the inner surface 166 defining the central chamber 162. The contour or shape of the inner surface 166 may follow the contour or shape of the outer surface 164. Thus, the inner surface 166 may have the same contour as the outer surface 164, as illustrated. Where the outer surface 164 of the middle section 156 is curved in an approximate elliptical shape, the inner surface 164 of the middle section 156 may also be curved in an approximate elliptical shape. The central chamber 162 may be open through the end of the extended flange, forming an opening 168.

As illustrated, passages may be formed through the flange section 154 and the portion of the middle section 156 in which the central chamber 162 is not formed. These passages generally pass through the flange section 154 and a portion of the middle section 156 to connect with the central chamber 162. A center passage 170 may be formed in the approximate center of the flange section 154 and generally pass through a portion of the middle section 156 to connect with the central chamber 162. An outer passage 172 may be formed around the periphery of the center passage. The outer passage 172 may also pass through a portion of the middle section 156 to connect with the central chamber 162.

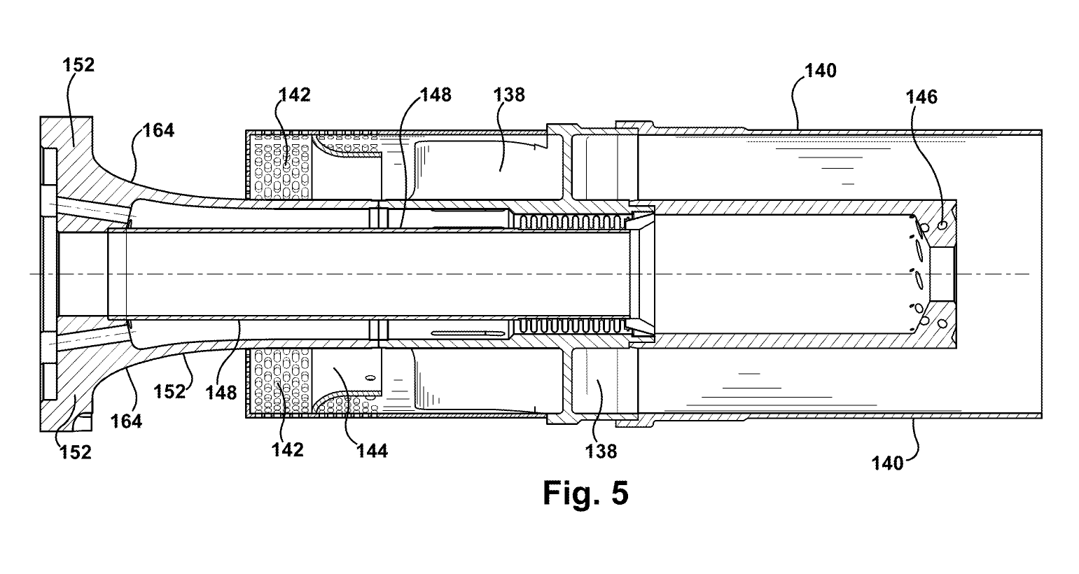

As illustrated in FIG. 5, the extended flange 152 may be used to effectively secure the fuel nozzle 108 to the end cover 106, while delivering a supply of fuel to the swozzle 138 and providing enhanced aerodynamics for the delivery of compressed air to the inlet flow conditioner 142. For example, the elliptical profile of the outer surface 164 of the middle section 156 distributes the mechanical loading evenly through the part, thus, avoiding stress concentrations. The elliptical profile of the inner surface 166 of the middle section 156 similarly distributes mechanical loading evenly through the part. In addition, the elliptical profile of the outer surface 164 and the elliptical profile of the inner surface 166 of the middle section 156 provides enhanced aerodynamics by smoothing the turbulent flow that occurs around these areas. In particular, the outer surface 164 of the middle section 156 is an area that generally directs the flow of rapidly moving compressed air toward the inlet flow conditioner 142. The elliptical profile of the outer surface 164 provides a smooth surface that reduces the aerodynamic load on the part while calming the turbulent flow of the compressed air as it enters the inlet flow conditioner 142. As one of ordinary skill in the art will appreciate, in some embodiments, the elliptical or multi-radial contour of the outer surface 164 and/or inner surface 166 may be designed to provide an optimized balance between frequency margin, low cycle fatigue capability, high cycle fatigue capability, and aerodynamic impact. The inner elliptical surface 166 and outer elliptical surface 164 may be optimized to reduce stress concentrations, minimize aerodynamic impact, and maximize frequency margin from key driving frequencies by adjusting the elliptical surface profile through the major/minor axes. High cycle fatigue is optimized by minimizing stress concentrations and maximizing frequency margin. Low cycle fatigue is optimized by an even distribution of the stress field across the part. Providing a smooth transition to turn the flow may reduce the aerodynamic impact. Adjusting the overall stiffness of the fuel nozzle 130 allows for the ability to maximize the margin between natural frequency and excitation source frequencies. The combination of these characteristics may provide an improved fuel nozzle 130 capable of achieving its life cycle requirements.

In addition, the connection between the outer tube 136 and the flange 132 is eliminated with the extended flange 152. As described, the extended flange 152 may be an integral part, i.e., formed as a single piece. The elimination of this connection saves costs associated with assembling the fuel nozzle. Further, it also provides greater durability to the fuel nozzle. The brazed connection made between a conventional outer tube 136 and flange 132 generally has a shorter operational part life than a similar part that is formed as a single piece. The brazed connection also occasionally fails during operation requiring significant repairs to the combustor unit.

From the above description of preferred embodiments of the invention, those skilled in the art will perceive improvements, changes and modifications. Such improvements, changes and modifications within the skill of the art are intended to be covered by the appended claims. Further, it should be apparent that the foregoing relates only to the described embodiments of the present application and that numerous changes and modifications may be made herein without departing from the spirit and scope of the application as defined by the following claims and the equivalents thereof.

We claim:

1. A fuel nozzle for a gas turbine combustor, comprising:
an extended flange, wherein, at a first end, the extended flange is configured to engage an end cover, thereby securing the position of the fuel nozzle within the combustor, and, at a second end, the extended flange is configured to engage a swozzle, within which a supply of fuel and compressed air is mixed during the operation of the combustor;
wherein the extended flange is formed as a single piece.

2. The fuel nozzle according to claim 1, wherein, when installed within the combustor, the extended flange has an axial thickness of at least approximately 3.75 inches.

3. The fuel nozzle according to claim 1, wherein:
the extended flange comprises a flange section, a middle section, and a tube section;
the flange section comprises a cylindrical shape;
the middle section comprises a curved surface that transitions from a surface of the flange section to a surface of the tube section; and
the tube section comprises a cylindrical shape that extends away from the middle section.

4. The fuel nozzle according to claim 3, wherein the flange section comprises a cylindrical shape that is between 1.0 and 3.5 inches in diameter and that, when installed, comprises an axial thickness of between approximately 0.25 and 0.75 inches.

5. The fuel nozzle according to claim 3, the middle section comprises an approximate flared cylinder, the flared cylinder having a larger diameter where the middle section connects to the flange section and a smaller diameter where the middle section connects to the tube section.

6. The fuel nozzle according to claim 5, wherein the middle section transitions from a radially oriented surface of the flange section to an axially oriented surface of the tube section.

7. The fuel nozzle according to claim 5, wherein the curved surface that transitions from the surface of the flange section to the surface of the tube section comprises an approximate smooth elliptical surface.

8. The fuel nozzle according to claim 5, wherein the curved surface that transitions from the surface of the flange section to the surface of the tube section comprises a smooth multi-radial curve.

9. The fuel nozzle according to claim 3, wherein the axial thickness of the middle section is between approximately 0.5 and 1.0 inches.

10. The fuel nozzle according to claim 3, wherein axial thickness of the tube section is between approximately 3.0 and 9.0 inches.

11. The fuel nozzle according to claim 1, wherein the axial thickness of the extended flange is between approximately 3.75 and 10.75 inches

12. The fuel nozzle according to claim 1, wherein the axial thickness of the extended flange comprises the distance required such that, when the first end of the extended flange is connected to the end cover and the second end is connected to the swozzle, the fuel nozzle comprises a desired installed position within the combustor.

13. The fuel nozzle according to claim 5, wherein a portion of the middle section and the tube section are substantially hollow, forming a central chamber therein; and
wherein, the portion of the middle section and the tube section comprise an outer surface and an inner surface, with the inner surface defining the central chamber.

14. The fuel nozzle according to claim 13, wherein, at the portion of the middle section in which the central chamber is formed, the inner surface comprises a contour that is substantially similar to the approximate elliptical contour of the outer surface.

15. The fuel nozzle according to claim 14, wherein the inner surface of the middle section comprises an approximate elliptical shape.

16. The fuel nozzle according to claim 13, further comprising a center passage that is formed through the approximate center of the flange section that extends through at least a portion of the middle section to connect with the central chamber; and
an outer passage that is formed around the periphery of the center passage, the outer passage extending through at least a portion of the middle section to connect with the central chamber.

17. A fuel nozzle for a gas turbine combustor, comprising:
an extended flange, wherein, at a first end, the extended flange is configured to engage an end cover, thereby securing the position of the fuel nozzle within the combustor, and, at a second end, the extended flange is configured to engage a swozzle, within which a supply of fuel and compressed air is mixed during the operation of the combustor;
wherein:
the extended flange is formed as a single piece;
the extended flange includes a flange section, a middle section, and a tube section;
the flange section comprises a cylindrical shape;
the middle section comprises a curved surface that transitions from a surface of the flange section to a surface of the tube section;
the tube section comprises a cylindrical shape that extends away from the middle section; and
the curved surface that transitions from the surface of the flange section to the surface of the tube section comprises an approximate smooth elliptical surface.

18. The fuel nozzle according to claim 17, wherein:
the axial thickness of the flange section is between approximately 0.25 and 0.75 inches;
the axial thickness of the middle section is between approximately 0.5 and 1.0 inches; and
the axial thickness of the tube section is between approximately 3.0 and 9.0 inches.

19. The fuel nozzle according to claim 17, wherein the axial thickness of the extended flange is between approximately 3.75 and 10.75 inches.

20. The fuel nozzle according to claim 19, wherein:
a portion of the middle section and the tube section are substantially hollow, forming a central chamber therein;
the portion of the middle section and the tube section comprise an outer surface and an inner surface, with the inner surface defining the central chamber; and
at the portion of the middle section in which the central chamber is formed, the inner surface comprises a contour that is substantially similar to the elliptical contour of the outer surface.
